(19) United States
(12) Patent Application Publication
(10) Pub. No.: US 2026/0195306 A1
(43) Pub. Date: Jul. 9, 2026

(54) ENHANCING ACCURACY OF INFORMATION PROVIDED BY ARTIFICIAL INTELLIGENCE CHATBOTS TO ADDRESS INFORMATION HALLUCINATION

(71) Applicant: International Business Machines Corporation, Armonk, NY (US)

(72) Inventors: Uri Kartoun, Cambridge, MA (US); Sophie Batchelder, Cambridge, MA (US); Krishnan Sugavanam, Mahopac, NY (US); Mauro Martino, Cambridge, MA (US)

(21) Appl. No.: 19/008,726

(22) Filed: Jan. 3, 2025

(51) Int. Cl. G06F 16/215; G06F 16/735; G06N 5/02

(52) U.S. Cl. CPC G06F 16/215; G06F 16/735; G06N 5/02

(57) ABSTRACT

Described are techniques for enhancing accuracy of information provided by artificial intelligence chatbots. A query requesting information is received. The semantics of the received query is then analyzed. The knowledge base may then be searched for the answer to the received query based on the analyzed semantics. A subsequent image and/or video search from a predetermined list of resources may then be performed to determine the level of accuracy of the answer (i.e., to validate the accuracy of the answer). The answer may be excluded from being provided in the response to the query if the accuracy of the answer is below a threshold level. In this manner, the risk of presenting incorrect information is mitigated thereby improving the reliability and accuracy of responses generated by artificial intelligence chatbots.

### TECHNICAL FIELD

The present disclosure relates generally to artificial intelligence chatbots.

### BACKGROUND

An artificial intelligence (AI) chatbot is a software program that uses artificial intelligence to simulate human-like conversations with users. AI chatbots are designed to understand a user's needs, preferences, and intent without the need for a human operator.

### SUMMARY

In one embodiment of the present disclosure, a computer-implemented method for enhancing accuracy of information provided by artificial intelligence chatbots comprises receiving a query requesting information. The method further comprises analyzing semantics of the query. The method additionally comprises searching a knowledge base for an answer to the query based on the analyzed semantics of the query. Furthermore, the method comprises performing one or more of a subsequent image search and a subsequent video search from a predetermined list of resources to determine an accuracy of the answer. Additionally, the method comprises excluding the answer from being provided in a reply to the query in response to the accuracy of the answer being below a threshold level.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 is a diagram of the software components used by the server for enhancing the accuracy of the information provided by artificial intelligence chatbots in accordance with an embodiment of the present disclosure;

FIG. 3 illustrates an embodiment of the present disclosure of the hardware configuration of the server which is representative of a hardware environment for practicing the present disclosure; and

FIGS. 4A-4B are a flowchart of a method for enhancing the accuracy of the information provided by artificial intelligence chatbots in accordance with an embodiment of the present disclosure.

### DETAILED DESCRIPTION

As stated above, an artificial intelligence (AI) chatbot is a software program that uses artificial intelligence to simulate human-like conversations with users. AI chatbots are designed to understand a user's needs, preferences, and intent without the need for a human operator.

For example, AI chatbots use natural language processing (NLP) and machine learning (ML) to understand and respond to user queries. They can adapt to user inputs over time and handle a wider range of issues more accurately and efficiently than traditional chatbots.

AI chatbots are used in a variety of applications, including customer service. For example, AI chatbots are used for answering frequently asked questions, providing product recommendations, and facilitating transactions.

AI chatbots are also used in e-commerce (e.g., providing personalized recommendations), healthcare (e.g., performing patient intake and appointment scheduling), market research (e.g., collecting survey responses), education (e.g., helping students with their homework), etc.

Unfortunately, such AI chatbots, such as OpenAI's ChatGPT®, may sometimes provide incorrect information with confidence, a phenomenon known as “information hallucination.” Information hallucination refers to when an artificial intelligence model, such as an AI chatbot, generates seemingly plausible but factually incorrect information, presenting it as if it were true, essentially “hallucinating” details that are not based on true facts. As a result, information hallucination can lead to misleading or harmful information being disseminated.

Currently, attempts have been made to improve the accuracy of the information provided by AI chatbots, such as by implementing fact-checking mechanisms. Unfortunately, such attempts were found as not sufficiently effective to enhance the accuracy of the information provided by AI chatbots.

The embodiments of the present disclosure provide a means for enhancing the accuracy of the information provided by artificial intelligence chatbots to address information hallucination. In one embodiment, an artificial intelligence chatbot receives a query requesting information. The artificial intelligence chatbot then searches a knowledge base for an answer to the query. During or after the artificial intelligence chatbot searches the knowledge base for an answer to the query, a subsequent image and/or video search is performed from a predetermined list of resources to determine the accuracy of the answer. That is, such a subsequent image and/or video search is performed to validate the accuracy of the answer. In one embodiment, the subsequent image and/or video search is performed on online resources that are provided from the predetermined list of resources. An online resource, as used herein, refers to any information, data, or tool that is accessible on the Internet, including textual information, images and videos, which can be accessed and used through a digital platform. In one embodiment, the resources are available on other sources than the Internet, such as data stored in national archives, or privately held by one or more organizations (e.g., commercial companies, non-profits). In one embodiment, such a verification process is performed by the AI chatbot that received the query requesting information or a different AI chatbot. In one embodiment, after performing such a subsequent image and/or video search, a determination is made as to the level of accuracy of the answer. For example, if the AI chatbot received the query (“What hobbies did John Doe have?”) and the answer generated by the AI chatbot in response to the query was that John Doe, the first prime minister of Country A, had several hobbies and interests outside of politics, including playing the violin, then a subsequent image and/or video search will be performed to determine if there are any images or videos involving John Doe playing the violin. Such a subsequent image and/or video search is performed to validate the accuracy of the answer, such as John Doe playing the violin. If, for example, after performing such a subsequent image and/or video search, it was discovered that there were no publicly available images or videos of John Doe playing a violin, then the level of accuracy of the answer pertaining to John Doe playing a violin will be deemed to be low. In one embodiment, when such a level of accuracy is below a threshold level, which may be user-designated, then such an answer is excluded from being provided in the response to the query. In this manner, the risk of presenting incorrect information is mitigated thereby improving the reliability and accuracy of responses generated by AI chatbots. These and other features will be discussed in further detail below.

In some embodiments of the present disclosure, the present disclosure comprises a computer-implemented method, system, and computer program product for enhancing accuracy of information provided by artificial intelligence chatbots. In one embodiment of the present disclosure, a query requesting information (e.g., query requesting the summarization of the key points of the article entitled “The Impact of AI on the Workplace”) is received. The semantics of the received query is then analyzed. Analyzing the semantics of a query, as used herein, refers to examining the underlying meaning and context of a question, search phrase, or task request, to understand the user's intent and the relationships between the concepts mentioned in the query. The knowledge base may then be searched for the answer to the received query based on the analyzed semantics. A knowledge base, as used herein, refers to either centralized or one or more distributed repositories of information that store data and knowledge related to a specific topic, product, or service. For example, based on analyzing the semantics of the query of “What hobbies did John Doe have?”, the knowledge base is searched for information pertaining to the hobbies of Country A's first prime minister, John Doe, thereby forming an answer to the query. For example, the answer to the query may be that John Doe, the first prime minister of Country A, had several hobbies and interests outside of politics, including playing the violin. A subsequent image and/or video search from a predetermined list of resources may then be performed to determine the level of accuracy of the answer (i.e., to validate the accuracy of the answer). For example, a subsequent image and/or video search may then be performed to validate the accuracy of the answer, such as John Doe playing the violin. In one embodiment, a machine learning model is trained to determine how well the visual evidence in the searched image and/or video aligns with the activity and/or individual mentioned in the query thereby determining the accuracy of the answer to the received query. After training the machine learning model to determine how well the visual evidence in the searched image and/or video aligns with the activity and/or individual mentioned in the query, the search results (results of the subsequent image and/or video search) are inputted into the trained machine learning model, which outputs a value, such a value between 0 and 1, which indicates the level of accuracy of the answer. The answer may then be presented in the response to the query if the accuracy of the answer is not below a threshold level, which may be user-designated. Alternatively, the answer may be excluded from being provided in the response to the query if the accuracy of the answer is below the threshold level. In this manner, the risk of presenting incorrect information is mitigated thereby improving the reliability and accuracy of responses generated by AI chatbots.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

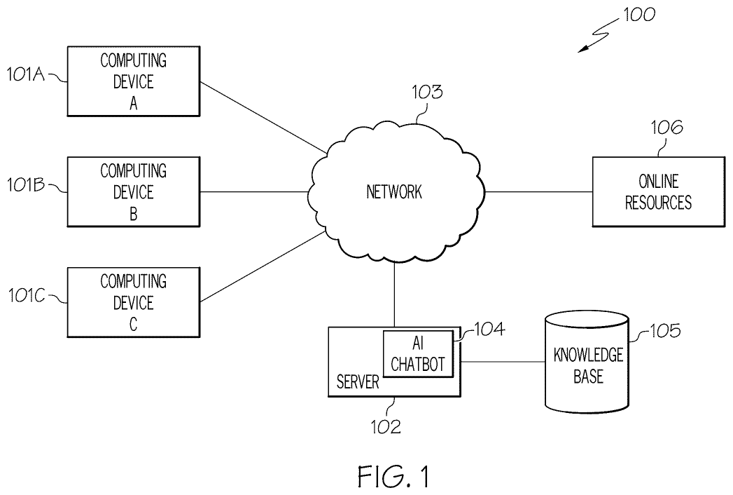

Referring now to the Figures in detail, FIG. 1 illustrates an embodiment of the present disclosure of a communication system 100 for practicing the principles of the present disclosure. Communication system 100 includes computing devices 101A-101C (identified as “Computing Device A,” “Computing Device B,” and “Computing Device C,” respectively, in FIG. 1) connected to a server 102, such as hosted on a data center, via a network 103. Computing devices 101A-101C may collectively or individually be referred to as computing devices 101 or computing device 101, respectively.

Computing device 101 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance, kiosk, and the like) configured with the capability of connecting to network 103 and consequently communicating with other computing devices 101 and server 102. It is noted that both computing device 101 and the user of computing device 101 may be identified with element number 101.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 902.11 standards network, various combinations thereof, etc. Other networks, whose descriptions are omitted here for brevity, may also be used in conjunction with system 100 of FIG. 1 without departing from the scope of the present disclosure.

Server 102 may correspond to one of the servers in a data center that hosts an artificial intelligence (AI) chatbot 104. A server, such as server 102, is a computer or system that provides services, data, applications, or resources to end-user devices. A data center is a physical facility that houses and operates computing and networking equipment, such as servers (e.g., server 102) and related infrastructure (e.g., power supplies, cooling systems), used to centrally store, process, and distribute large amounts of data. An AI chatbot 104, as used herein, refers to a software program that uses artificial intelligence to simulate human-like conversations with users. As discussed above, AI chatbots are designed to understand a user's needs, preferences, and intent without the need for a human operator. For example, AI chatbots use natural language processing (NLP) and machine learning (ML) to understand and respond to user queries. They can adapt to user inputs over time and handle a wider range of issues more accurately and efficiently than traditional chatbots.

In one embodiment, users of computing device 101 may issue a query (query requesting information) to AI chatbot 104 hosted on server 102 via network 103. For example, the query issued by the user of computing device 101 may be to summarize the key points of the article entitled “The Impact of AI on the Workplace.”

In one embodiment, AI chatbot 104 analyzes the semantics of the query. Analyzing the semantics of the query, as used herein, refers to examining the underlying meaning and context of a question or search phrase to understand the user's intent and the relationships between the concepts mentioned in the query.

In one embodiment, AI chatbot 104 performs a search in a knowledge base, such as knowledge base 105 connected to server 102, for an answer to the query based on the analyzed semantics. A knowledge base, such as knowledge base 105, as used herein, refers to a centralized repository of information that stores data and knowledge related to a specific topic, product, or service. For example, the user of computing device 101 may have provided the query of “What hobbies did John Doe have?” Based on analyzing the semantics of the query, AI chatbot 104 searches knowledge base 105 for information pertaining to the hobbies of Country A Prime Minister John Doe.

After searching knowledge base 105 for an answer to the query based on the analyzed semantics, a subsequent image and/or video search is performed from a predetermined list of resources to determine the level of accuracy of the answer. That is, such a subsequent image and/or video search is performed to validate the accuracy of the answer. In one embodiment, the subsequent image and/or video search is performed on online resources 106 that are provided from the predetermined list of resources. An online resource 106, as used herein, refers to any information, data, or tool that is accessible via a network, such as network 103, including images and videos, which can be accessed and used through a digital platform. In one embodiment, such a verification process is performed by AI chatbot 104 that received the query requesting information or a different AI chatbot, such as an AI chatbot hosted on a different server located in a data center.

In one embodiment, after performing such a subsequent image and/or video search, server 102 determines the level of accuracy of the answer. For example, if the answer generated by the AI chatbot in response to the query was that John Doe, the first prime minister of Country A, had several hobbies and interests outside of politics, including playing the violin, then a subsequent image and/or video search will be performed to determine if there are any images or videos involving John Doe playing the violin. If, for example, after performing such a subsequent image and/or video search, it was discovered that there were no publicly available images or videos of John Doe playing a violin, then the level of accuracy of the answer pertaining to John Doe playing a violin will be deemed to be low.

In one embodiment, server 102 provides the answer in the response to the query when the level of accuracy of the answer is not below a threshold level, which may be user-designated. Alternatively, server 102 excludes the answer from being provided in the response to the query when the level of accuracy of the answer is below a threshold level, which may be user-designated. In this manner, the risk of presenting incorrect information is mitigated thereby improving the reliability and accuracy of responses generated by AI chatbots.

A further discussion regarding these and other features is provided below.

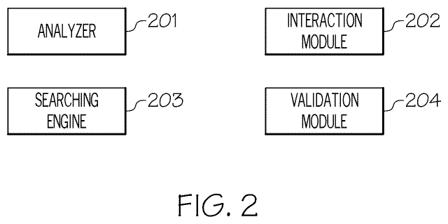

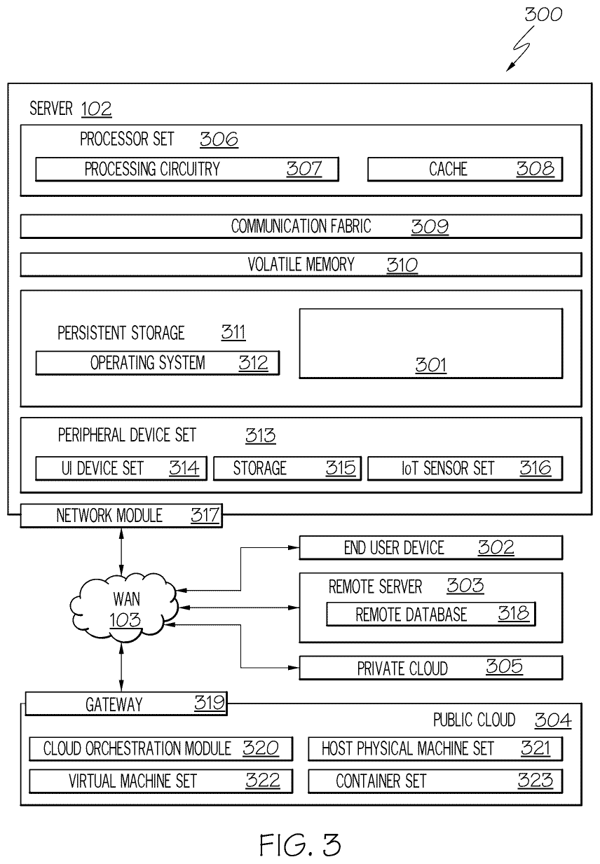

A description of the software components of server 102 used for enhancing the accuracy of the information provided by artificial intelligence chatbots is provided below in connection with FIG. 2. A description of the hardware configuration of server 102 is provided further below in connection with FIG. 3.

System 100 is not to be limited in scope to any one particular network architecture. System 100 may include any number of computing devices 101, servers 102, networks 103, AI chatbots 104, and knowledge bases 105.

A discussion regarding the software components used by server 102 for enhancing the accuracy of the information provided by artificial intelligence chatbots is provided below in connection with FIG. 2.

FIG. 2 is a diagram of the software components used by server 102 for enhancing the accuracy of the information provided by artificial intelligence chatbots (e.g., AI chatbot 104) in accordance with an embodiment of the present disclosure. It is noted that some or all of the components discussed herein in connection with FIG. 2 may be part of AI chatbot 104.

Referring to FIG. 2, in conjunction with FIG. 1, server 102 includes analyzer 201 configured to receive a query, such as a query issued from a user of computing device 101, requesting information.

In one embodiment, users of computing device 101 may issue a query (query requesting information) to AI chatbot 104 hosted on server 102 via network 103. A query, as used herein, refers to a question or request for information that a user, such as a user of computing device 101, types into a user interface, such as a user interface of computing device 101. For example, the query issued by the user of computing device 101 may be to summarize the key points of the article entitled “The Impact of AI on the Workplace.” In one embodiment, the query may be verbally provided by the user to computing device 101 capable of processing speech (using a microphone). In one embodiment, the result or summary may be verbally provided to the user by computing device 101 (e.g., using a speaker).

In one embodiment, analyzer 201 is configured to analyze the semantics of the received query. Analyzing the semantics of a query, as used herein, refers to examining the underlying meaning and context of a question or search phrase to understand the user's intent and the relationships between the concepts mentioned in the query.

In one embodiment, analyzer 201 analyzes the semantics of the received query by identifying key entities, analyzing parts of speech, understanding the context through related words and phrases, and leveraging word embeddings to calculate semantic similarity.

In one embodiment, analyzer 201 analyzes the semantics of the received query by preprocessing the query, such as by performing tokenization, stemming/Lemmatization, and stop word removal.

Tokenization, as used herein, refers to splitting the query into individual words called “tokens.” In one embodiment, analyzer 201 utilizes various software tools for performing tokenization, which can include, but are not limited to, NLTK, Gensim, TextBlob, Keras®, etc.

Stemming and Lemmatization, as used herein, are text pre-processing techniques that reduce words to their base form (root or lemma) allowing for better identification of similar meanings across different word variations thereby enhancing the accuracy of semantic analysis by grouping related words together despite their different inflections. In one embodiment, analyzer 201 utilizes various software tools for performing stemming/Lemmatization, which can include, but are not limited to, NLTK, spaCy®, CoreNLP, etc.

Stop word removal, as used herein, refers to removing common words, such as “the” and “a,” that do not add significant meaning. In one embodiment, analyzer 201 utilizes various software tools for performing stop word removal, which can include, but are not limited to, NLTK, spaCy®, Gensim, etc.

In one embodiment, upon preprocessing the query, analyzer 201 performs entity recognition, which identifies the named entities, such as people, places, organizations, and dates, within the query. In one embodiment, analyzer 201 utilizes various software tools for performing entity recognition, which can include, but are not limited to, NLTK, spaCy®, AllenNLP, etc.

In one embodiment, following entity recognition, analyzer 201 performs part-of-speech tagging, which identifies the grammatical role of each token (e.g., noun, verb, adjective, etc.). In one embodiment, analyzer 201 utilizes various software tools for performing part-of-speech tagging, which can include, but are not limited to, NLTK, CoreNLP, spaCy®, TextBlob, etc.

Furthermore, in one embodiment, upon performing part-of-speech tagging, analyzer 201 performs semantic analysis, such as by performing the word embedding technique, which represents words as numerical vectors in a multi-dimensional space. That is, the word embedding technique converts words into vectors in a high-dimensional space where words with similar meanings are closer together. In one embodiment, analyzer 201 utilizes various software tools for performing the word embedding technique, which can include, but are not limited to, Gensim, spaCy®, TensorFlow®, etc.

In one embodiment, analyzer 201 then calculates the similarity between the query vector and vectors representing known concepts to identify the most relevant meanings, such as by calculating the cosine similarity between such vectors. Cosine similarity, as used herein, refers to measuring the similarity between two vectors by calculating the cosine of the angle between them. In one embodiment, analyzer 201 utilizes various software tools for calculating the cosine similarity, which can include, but are not limited to, TensorFlow®, Matlab®, etc.

Furthermore, in one embodiment, analyzer 201 performs contextual analysis to consider the surrounding words and phrases to understand the broader context of the query. In one embodiment, analyzer 201 utilizes various software tools for performing contextual analysis, which can include, but are not limited to, spaCy®, NLTK, CoreNLP, etc.

In one embodiment, analyzer 201 determines if the analyzed semantics of the received query is within a threshold degree of similarity, which may be user-designated, to the analyzed semantics of a prior query. In one embodiment, the semantics of a query that were analyzed by analyzer 201 are stored in a data structure (e.g., table). In one embodiment, analyzer 201 performs a lookup in such a data structure to compare the similarity between the analyzed semantics of the received query and the analyzed semantics of previously analyzed queries. In one embodiment, such a data structure is stored in the storage medium of server 102.

In one embedment, such a similarity analysis is performed by vectorizing the analyzed semantics of the received query as well as the analyzed semantics of the previously analyzed queries which are stored in the data structure discussed above. In one embodiment, analyzer 201 calculates the distance between such vector representations, such as by calculating the cosine similarity between such vector representations (e.g., between the vector representation of the analyzed semantics of the received query and the vector representation of the analyzed semantics of a prior analyzed query). Such a distance represents the degree of similarity between the analyzed semantics of the received query and the analyzed semantics of a prior query. In one embodiment, in connection with calculating the cosine similarity, the closer the value is to 1, the higher the semantic similarity.

In one embodiment, analyzer 201 determines if the analyzed semantics of the received query is within a threshold degree of similarity, which may be user-designated, to the analyzed semantics of a prior query based on determining if the calculated distance between the vector representations of such analyzed semantics exceeds a threshold value (e.g., 0.95), which may be user-designated.

Referring to FIG. 2, server 102 further includes interaction module 202 configured to return responses to user queries.

In one embodiment, if the analyzed semantics of the received query is within a threshold degree of similarity to the analyzed semantics of a prior query, then interaction module 202 obtains the answer to the prior query, which is presented as the response to the received query. That is, interaction module 202 issues a response to the query requesting information, which includes the answer to the prior query with analyzed semantics that are within a threshold degree of similarity to the analyzed semantics of the received query.

In one embodiment, answers to queries are stored in a data structure (e.g., table). For example, answers to queries that are provided to users by interaction module 202 are stored in such a data structure. In one embodiment, such answers stored in the data structure are associated with the queries. As a result, upon interaction module 202 identifying the query in the data structure whose analyzed semantics are within a threshold degree of similarity to the analyzed semantics of the received query, interaction module 202 is able to identify the associated answer. Such an answer is then presented as the response to the received query. In one embodiment, the data structure could be one or more of the following: key-value stores, document stores, graph databases, time-series databases, columnar databases, object storage, file-based systems, in-memory data grids, blockchain, semantic stores, etc.

If, however, the analyzed semantics of the received query is not within a threshold degree of similarity to the analyzed semantics of a prior query, then searching engine 203 of server 102 searches knowledge base 105 for the answer to the received query based on the analyzed semantics. A knowledge base, such as knowledge base 105, as used herein, refers to either centralized or one or more distributed repositories of information that store data and knowledge related to a specific topic, product, or service. For example, the user of computing device 101 may have provided the query of “What hobbies did John Doe have?” Based on analyzing the semantics of the query by analyzer 201, searching engine 203 searches knowledge base 105 for information pertaining to the hobbies of Country A Prime Minister John Doe.

In one embodiment, searching engine 203 compares the meaning of the semantic representations of the knowledge base entries with the semantic representation of the received query. For example, in one embodiment, the analyzed semantics of the received query may be represented as a vector as discussed above. Furthermore, in one embodiment, the knowledge base entries are represented as vectors. For example, in one embodiment, each piece of information in the knowledge base is converted into a vector representation, such as via the word embedding technique. As a result, a numerical comparison of semantic similarity may be performed between the query and the knowledge base entries.

In one embodiment, searching engine 203 performs such a numerical comparison by performing a vector similarity search, which compares the query vector to the vectors of each knowledge base entry to identify the most semantically similar ones. In one embodiment, such results may be ranked based on relevance, such as the distance between the vectors, the context of the knowledge base entry, and any additional semantic information to refine the ranking of potential answers.

In one embodiment, searching engine 203 identifies the knowledge base entry that best matches the semantic meaning of the query as corresponding to the answer to the query.

For example, the user of computing device 101 may have provided the query of “What hobbies did John Doe have?” Based on the analyzed semantics of the query, searching engine 203 searches knowledge base 105 for information pertaining to the hobbies of Country A Prime Minister John Doe. That is, based on the analyzed semantics of the query, searching engine 203 searches knowledge base 105 for an answer to the query. An example of an answer to such a query is provided below:
John Doe, the first Prime Minister of Country A, had several hobbies and interests outside of politics. Some of his known hobbies were:
1. Hiking—Ben-Gurion was an avid hiker and spent much of his free time exploring the desert and mountains of the region.
2. Reading—He was an avid reader and particularly enjoyed books on history and philosophy.
3. Writing—Ben-Gurion was a prolific writer and wrote many books and articles on politics and history.
4. Playing the violin—He was a skilled violin player and enjoyed playing classical music.
5. Gardening—Ben-Gurion had a love for gardening and enjoyed spending time tending to his plants and trees.
6. Studying languages—He had a passion for learning languages and was fluent in Hebrew, Yiddish, English, Russian, French, Spanish, and Turkish.
Overall, Ben-Gurion was a multifaceted person with a wide range of interests and hobbies.

In one embodiment, searching engine 203 searches knowledge base 105 for the answer to the query based on the analyzed semantics using various software tools, which can include, but are not limited to, IBM Watson® Discovery, Bloomfire®, etc.

Furthermore, in one embodiment, server 102 includes validation module 204 configured to validate the accuracy of the answer. In one embodiment, validation module 204 validates the accuracy of the answer by performing a subsequent image and/or video search from a predetermined list of resources to determine the accuracy of the answer.

In one embodiment, prior to performing the subsequent image and/or video search, validation module 204 determines whether the answer provided by searching engine 203 includes a name associated with more than one individual, such as multiple well-known individuals.

For example, the answer could include a name, such as Michael Jackson, which could refer to multiple individuals, such as the singer Michael Jackson or the radio host Michael Jackson.

In one embodiment, validation module 204 determines whether the answer provided by searching engine 203 includes a name associated with more than one individual, such as multiple well-known individuals, by searching a data structure (e.g., table) containing a listing of celebrities, public figures, prominent persons, etc. who have the same name as other celebrities, public figures, prominent persons, etc. For example, in one embodiment, validation module 204 performs a search in such a data structure using the names included in the answer to determine if such a name also refers to another individual, including another well-known individual. Upon identifying a matching name in the data structure, validation module 204 may then conclude that such a name is associated with more than one individual. In one embodiment, such a data structure is populated by an expert. In one embodiment, such a data structure resides within the storage device of server 102.

In one embodiment, in response to determining that the answer provided by searching engine 203 includes a name associated with more than one individual, validation module 204 performs a subsequent image and/or video search for each individual (e.g., Michael Jackson the singer and Michael Jackson the radio host) to determine the accuracy of the answer.

Alternatively, in one embodiment, validation engine 204 generates a notification to the user, such as the user of computing device 101 that issued the query requesting information, requesting clarification as to which individual is discussed in the answer. In one embodiment, such a notification is sent to the user of computing device 101 that issued the query requesting information via an email message, a short message service (SMS) message, a mobile push notification (through an application), a web push notification (on a website), etc.

In one embodiment, upon receiving confirmation as to which individual is the correct individual that is named in the answer, validation engine 204 performs a subsequent image and/or video search from a predetermined list of resources involving that individual to determine the accuracy of the answer as discussed below.

Alternatively, in one embodiment, validation engine 204 randomly selects one of the individuals (e.g., Michael Jackson the singer) as the individual that is allegedly named in the answer. Validation engine 204 then performs a subsequent image and/or video search from a predetermined list of resources involving that individual to determine the accuracy of the answer as discussed below. In such an embodiment, validation engine 204 provides an indication, such as to the user of computing device 101 that issued the query requesting information, regarding the existence of other individuals with the same name. In one embodiment, such a notification is sent to the user of computing device 101 that issued the query requesting information via an email message, a short message service (SMS) message, a mobile push notification (through an application), a web push notification (on a website), etc.

Furthermore, if validation module 204 determines that the answer provided by searching engine 203 does not include a name associated with more than one individual, then validation module 204 proceeds with performing a subsequent image and/or video search from a predetermined list of resources, such as involving the individual mentioned in the answer, to determine the accuracy of the answer as discussed below.

In one embodiment, validation module 204 performs the subsequent image and/or video search from a predetermined list of resources to determine the level of accuracy of the answer (i.e., to validate the accuracy of the answer) by performing such a subsequent image and/or video search on online resources 106, which are provided from the predetermined list of resources. An online resource 106, as used herein, refers to any information, data, or tool that is accessible via a network, such as network 103, including images and videos, which can be accessed and used through a digital platform.

In one embodiment, validation module 204 performs the subsequent image and/or video search by looking for visual evidence of a specific activity mentioned in the answer. For example, referring to the example of an answer provided by searching engine 203 regarding John Doe, where the answer included the alleged fact that a hobby of John Doe was that he played the violin, specifically, that he was a skilled violin player and enjoyed playing classical music. As a result, in order to verify the accuracy of such a fact, validation module 204 performs a subsequent image and/or video search looking for visual evidence of John Doe playing the violin.

In one embodiment, validation engine 204 performs a keyword search in the answer provided by searching engine 203 for words directed to an activity, such as playing the violin. In one embodiment, validation engine 204 performs such a keyword search based on a data structure (e.g., table) that includes a listing of terms associated with activities. In one embodiment, validation engine 204 performs a lookup in such a data structure to identify any terms associated with activities that are listed in the answer provided by searching engine 203. Upon identifying such a matching term, validation engine 204 then performs the subsequent image and/or video search by looking for visual evidence of such a specific activity mentioned in the answer. In one embodiment, such a data structure is populated by an expert. In one embodiment, such a data structure is stored in the storage device of server 102.

In one embodiment, validation engine 204 performs a subsequent image and/or video search by looking for visual evidence of a specific activity by utilizing a search engine (e.g., Google®, Bing®, etc.). For example, a descriptive phrase (e.g., “John Doe playing violin”) is inputted into the search bar of the search engine. In one embodiment, validation engine 204 may indicate that such a search is a search for an image and/or video.

In one embodiment, validation module 204 analyzes the results of the image and/or video search performed by the search engine for visual evidence of a specific activity. For example, referring to the example above pertaining to the answer indicating that John Doe plays the violin, the search engine may indicate that there are no publicly available images with John Doe playing the violin. There are, however, publicly available images with John Doe writing as a hobby.

In one embodiment, validation module 204 analyzes the images and/or videos identified by the search engine to confirm that such images and/or videos provide visual evidence of a specific activity. In one embodiment, validation module 204 uses computer vision techniques, such as via machine learning models, to detect and track a person (e.g., John Doe) in the image and/or video. Such actions in the image and/or video may then be classified, such as based on body posture, movement patterns, and surrounding context. In one embodiment, such a classification is performed using object detection, pose estimation, and activity recognition. In one embodiment, validation module 204 utilizes various software tools for performing such an analysis of the images and/or videos, which can include, but are not limited to, Amazon Rekognition®, Microsoft® Azure® Cognitive Services, TensorFlow®, etc.

In one embodiment, validation module 204 analyzes the images and/or videos identified by the search engine to confirm that such images and/or videos provide visual evidence of a specific activity by first performing image/video preprocessing followed by feature extraction followed by activity classification.

In one embodiment, such image/video preprocessing involves object detection, which identifies the designated individual in each frame using object detection algorithms (e.g., Faster Region-Convolutional Neural Network, small data-driven) to isolate their body from the background. Furthermore, in one embodiment, such image/video preprocessing involves pose estimation, which utilizes pose estimation techniques (e.g., OpenPose) to extract key points on the person's body (e.g., joints) to analyze their posture and movement.

In one embodiment, feature extraction involves motion analysis, which analyzes the movement of the detected keypoints over time to identify patterns associated with specific activities. Furthermore, feature extraction involves contextual features, such as location, surrounding objects, or the scene, to improve activity recognition accuracy. In one embodiment, validation module 204 performs feature extraction using various software tools, which can include, but are not limited to, VisionTool, Matlab®, OpenCV®, etc.

In one embodiment, activity classification involves training a machine learning model (e.g., convolutional neural network) on labeled data of various activities to classify the detected actions in each frame. In one embodiment, activity classification involves using recurrent neural networks that are trained, such as via backpropagation through time, to identify activities based on the temporal relationships between video frames. As a result, such a trained recurrent neural network is able to classify actions, such as actions being performed between video frames.

In one embodiment, validation module 204 performs the subsequent image and/or video search by employing face recognition techniques to identify all individuals associated with the answer.

For example, if the answer mentions an individual, such as John Doe, then validation module 204 may employ a face recognition technique to identify John Doe in the images and/or videos that were searched by validation module 204, such as the images and/or videos that were searched in online resources 106. In one embodiment, validation module 204 performs face recognition to identify a particular individual in an image and/or video by first detecting a face within the image and/or video and analyzing its key facial features, such as the distance between the eyes, shape of the nose, jawline, etc., so as to create a unique “faceprint” which is compared to a known image of the person (e.g., John Doe) in question. In one embodiment, knowledge base 105 may be populated with images of individuals that are known to be correct. As a result, validation module 204 may be configured to search knowledge base 105 for an image of an individual mentioned in the answer and use such an image when it performs face recognition in connection with the images and/or videos that were searched by validation module 204. In one embodiment, such images of individuals that are known to be correct are populated in knowledge base 105 by an expert. In one embodiment, images of individuals that are known to be correct are populated in a storage device of server 102.

In one embodiment, validation module 204 utilizes various software tools for employing a face recognition technique as discussed above to identify an image of an individual mentioned in the answer in the images and/or videos that were searched by validation module 204, such as the images and/or videos that were searched in online resources 106, which can include, but are not limited to, FaceFirst®, Amazon Rekognition®, DeepFace, etc.

In one embodiment, validation module 204 analyzes the results of the image and/or video searched for visual evidence of a specific activity being performed by a specific individual mentioned in the answer to determine a level of accuracy of the answer by determining how well the visual evidence in the searched image and/or video aligns with the activity and/or individual mentioned in the query.

For example, in one embodiment, validation module 204 trains a machine learning model to determine how well the visual evidence in the searched image and/or video aligns with the activity and/or individual mentioned in the query. In one embodiment, such a determination is provided as a value, such as a number between 0 and 1, where the value of 1 corresponds to a perfect alignment between the visual evidence in the searched image and/or video and the activity and/or individual mentioned in the query and where the value of 0 corresponds to the opposite case, in which there is no alignment between the visual evidence in the searched image and/or video and the activity and/or individual mentioned in the query.

In one embodiment, validation module 204 trains the machine learning model to determine how well the visual evidence in the searched image and/or video aligns with the activity and/or individual mentioned in the query based on a sample data set, which may include images and/or videos of various activities as well as a value associated with each image or video which indicates how closely aligned such an image or video is to a particular activity (e.g., reading a book, playing the violin) and/or individual (e.g., famous people, public figures). In one embodiment, such a sample data set is populated by an expert. In one embodiment, such a sample data set is stored in knowledge base 105. In one embodiment, such a sample data set is stored in a storage device of server 102.

Furthermore, in one embodiment, the sample data set discussed above is referred to herein as the “training data,” which is used by a machine learning algorithm to make predictions or decisions, such as how well the visual evidence in the searched image and/or video aligns with the activity and/or individual mentioned in the query. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Upon training the machine learning model to determine how well the visual evidence in the searched image and/or video aligns with the activity and/or individual mentioned in the query, validation module 204 determines the accuracy of the answer based on inputting the search results (results of the subsequent image and/or video search, including the results of the subsequent image and/or video search for each of the individuals when there is more than one individual mentioned in the answer) into the trained machine learning model. In one embodiment, the trained machine learning model outputs a value, such a value between 0 and 1, which indicates the level of accuracy of the answer.

In one embodiment, interaction module 202 compares such a value to a threshold value, which may be user-designated, to determine if the accuracy of the answer is below a threshold level.

If the accuracy of the answer is not below the threshold level, then interaction module 202 presents the answer in the response to the received query.

If, however, the accuracy of the answer is below the threshold level, then interaction module 202 excludes the answer from being provided in the reply to the answer. In this manner, the risk of presenting incorrect information is mitigated thereby improving the reliability and accuracy of responses generated by AI chatbots.

A further description of these and other features is provided below in connection with the discussion of the method for enhancing the accuracy of the information provided by artificial intelligence chatbots.

Prior to the discussion of the method for enhancing the accuracy of the information provided by artificial intelligence chatbots, a description of the hardware configuration of server 102 (FIG. 1) is provided below in connection with FIG. 3.

Referring now to FIG. 3, in conjunction with FIG. 1, FIG. 3 illustrates an embodiment of the present disclosure of the hardware configuration of server 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code (stored in block 301) involved in performing the inventive methods, such as enhancing the accuracy of the information provided by artificial intelligence chatbots. In addition to block 301, computing environment 300 includes, for example, server 102, network 103, such as a wide area network (WAN), end user device (EUD) 302, remote server 303, public cloud 304, and private cloud 305. In this embodiment, server 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IOT) sensor set 316), and network module 317. Remote server 303 includes remote database 318. Public cloud 304 includes gateway 319, cloud orchestration module 320, host physical machine set 321, virtual machine set 322, and container set 323.

Server 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically server 102, to keep the presentation as simple as possible. Server 102 may be located in a cloud, even though it is not shown in a cloud in FIG. 3. On the other hand, server 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto server 102 to cause a series of operational steps to be performed by processor set 306 of server 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of server 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In server 102, the volatile memory 310 is located in a single package and is internal to server 102, but, alternatively or additionally, the volatile memory may be distributed over multiple packages and/or located externally with respect to server 102.

Persistent Storage 311 is any form of non-volatile storage for computers that is now known or to be developed in the future. The non-volatility of this storage means that the stored data is maintained regardless of whether power is being supplied to server 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of server 102. Data communication connections between the peripheral devices and the other components of server 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where server 102 is required to have a large amount of storage (for example, where server 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows server 102 to communicate with other computers through WAN 103. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to server 102 from an external computer or external storage device through a network adapter card or network interface included in network module 317.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates server 102), and may take any of the forms discussed above in connection with server 102. EUD 302 typically receives helpful and useful data from the operations of server 102. For example, in a hypothetical case where server 102 is designed to provide a recommendation to an end user, this recommendation would typically be communicated from network module 317 of server 102 through WAN 103 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to server 102. Remote server 303 may be controlled and used by the same entity that operates server 102. Remote server 303 represents the machine(s) that collect and store helpful and useful data for use by other computers, such as server 102. For example, in a hypothetical case where server 102 is designed and programmed to provide a recommendation based on historical data, then this historical data may be provided to server 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to enhance the accuracy of the information provided by artificial intelligence chatbots. In one embodiment, such components may be implemented in hardware. The functions discussed above performed by such components are not generic computer functions. As a result, server 102 is a particular machine that is the result of implementing specific, non-generic computer functions.

In one embodiment, the functionality of such software components of server 102, including the functionality for enhancing the accuracy of the information provided by artificial intelligence chatbots, may be embodied in an application specific integrated circuit.

As stated above, AI chatbots are designed to understand a user's needs, preferences, and intent without the need for a human operator. For example, AI chatbots use natural language processing (NLP) and machine learning (ML) to understand and respond to user queries. They can adapt to user inputs over time and handle a wider range of issues more accurately and efficiently than traditional chatbots. AI chatbots are used in a variety of applications, including customer service. For example, AI chatbots are used for answering frequently asked questions, providing product recommendations, and facilitating transactions. AI chatbots are also used in e-commerce (e.g., providing personalized recommendations), healthcare (e.g., performing patient intake and appointment scheduling), market research (e.g., collecting survey responses), education (e.g., helping students with their homework), etc. Unfortunately, such AI chatbots, such as OpenAI's ChatGPT®, may sometimes provide incorrect information with confidence, a phenomenon known as “information hallucination.” Information hallucination refers to when an artificial intelligence model, such as an AI chatbot, generates seemingly plausible but factually incorrect information, presenting it as if it were true, essentially “hallucinating” details that are not based on true facts. As a result, information hallucination can lead to misleading or harmful information being disseminated. Currently, attempts have been made to improve the accuracy of the information provided by AI chatbots, such as by implementing fact-checking mechanisms. Unfortunately, such attempts were found as not sufficiently effective to enhance the accuracy of the information provided by AI chatbots.

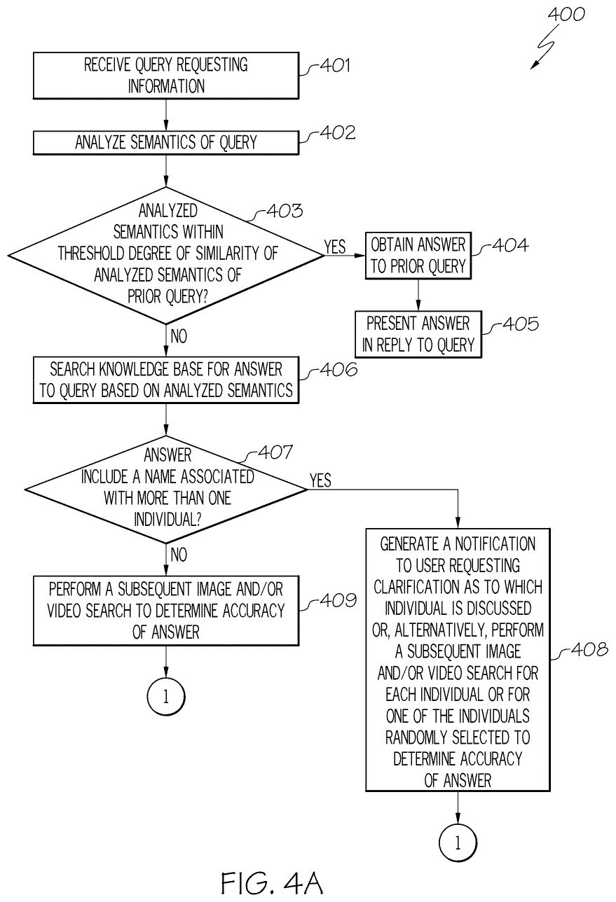

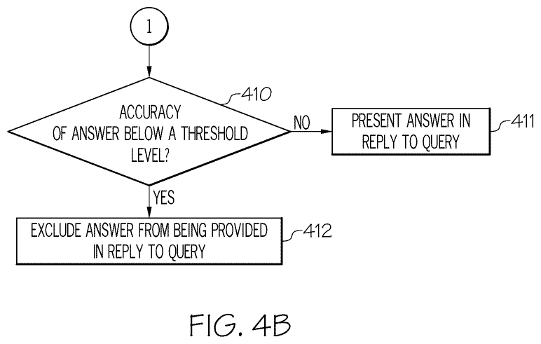

The embodiments of the present disclosure provide a means for enhancing the accuracy of the information provided by artificial intelligence chatbots to address information hallucination as discussed below in connection with FIGS. 4A-4B.

FIGS. 4A-4B are a flowchart of a method 400 for enhancing the accuracy of the information provided by artificial intelligence chatbots in accordance with an embodiment of the present disclosure.

Referring to FIG. 4A, in conjunction with FIGS. 1-3, in operation 401, analyzer 201 of server 102 receives a query, such as a query issued from a user of computing device 101, requesting information.

As discussed above, in one embodiment, users of computing device 101 may issue a query (query requesting information) to AI chatbot 104 hosted on server 102 via network 103. A query, as used herein, refers to a question or request for information that a user, such as a user of computing device 101, types into a user interface, such as a user interface of computing device 101. For example, the query issued by the user of computing device 101 may be to summarize the key points of the article entitled “The Impact of AI on the Workplace.” In operation 402, analyzer 201 of server 102 analyzes the semantics of the received query.

As stated above, analyzing the semantics of a query, as used herein, refers to examining the underlying meaning and context of a question or search phrase to understand the user's intent and the relationships between the concepts mentioned in the query.

In one embodiment, analyzer 201 analyzes the semantics of the received query by identifying key entities, analyzing parts of speech, understanding the context through related words and phrases, and leveraging word embeddings to calculate semantic similarity.

In one embodiment, analyzer 201 analyzes the semantics of the received query by preprocessing the query, such as by performing tokenization, stemming/Lemmatization, and stop word removal.

Tokenization, as used herein, refers to splitting the query into individual words called “tokens.” In one embodiment, analyzer 201 utilizes various software tools for performing tokenization, which can include, but are not limited to, NLTK, Gensim, TextBlob, Keras®, etc.

Stemming and Lemmatization, as used herein, are text pre-processing techniques that reduce words to their base form (root or lemma) allowing for better identification of similar meanings across different word variations thereby enhancing the accuracy of semantic analysis by grouping related words together despite their different inflections. In one embodiment, analyzer 201 utilizes various software tools for performing stemming/Lemmatization, which can include, but are not limited to, NLTK, spaCy®, CoreNLP, etc.

Stop word removal, as used herein, refers to removing common words, such as “the” and “a,” that do not add significant meaning. In one embodiment, analyzer 201 utilizes various software tools for performing stop word removal, which can include, but are not limited to, NLTK, spaCy®, Gensim, etc.

In one embodiment, upon preprocessing the query, analyzer 201 performs entity recognition, which identifies the named entities, such as people, places, organizations, and dates, within the query. In one embodiment, analyzer 201 utilizes various software tools for performing entity recognition, which can include, but are not limited to, NLTK, spaCy®, AllenNLP, etc.

In one embodiment, following entity recognition, analyzer 201 performs part-of-speech tagging, which identifies the grammatical role of each token (e.g., noun, verb, adjective, etc.). In one embodiment, analyzer 201 utilizes various software tools for performing part-of-speech tagging, which can include, but are not limited to, NLTK, CoreNLP, spaCy®, TextBlob, etc.

Furthermore, in one embodiment, upon performing part-of-speech tagging, analyzer 201 performs semantic analysis, such as by performing the word embedding technique, which represents words as numerical vectors in a multi-dimensional space. That is, the word embedding technique converts words into vectors in a high-dimensional space where words with similar meanings are closer together. In one embodiment, analyzer 201 utilizes various software tools for performing the word embedding technique, which can include, but are not limited to, Gensim, spaCy®, TensorFlow®, etc.

In one embodiment, analyzer 201 then calculates the similarity between the query vector and vectors representing known concepts to identify the most relevant meanings, such as by calculating the cosine similarity between such vectors. Cosine similarity, as used herein, refers to measuring the similarity between two vectors by calculating the cosine of the angle between them. In one embodiment, analyzer 201 utilizes various software tools for calculating the cosine similarity, which can include, but are not limited to, TensorFlow®, Matlab®, etc.

Furthermore, in one embodiment, analyzer 201 performs contextual analysis to consider the surrounding words and phrases to understand the broader context of the query. In one embodiment, analyzer 201 utilizes various software tools for performing contextual analysis, which can include, but are not limited to, spaCy®, NLTK, CoreNLP, etc.

In operation 403, analyzer 201 of server 102 determines if the analyzed semantics of the received query is within a threshold degree of similarity, which may be user-designated, to the analyzed semantics of a prior query.

As discussed above, in one embodiment, the semantics of a query that were analyzed by analyzer 201 are stored in a data structure (e.g., table). In one embodiment, analyzer 201 performs a lookup in such a data structure to compare the similarity between the analyzed semantics of the received query and the analyzed semantics of previously analyzed queries. In one embodiment, such a data structure is stored in the storage medium (e.g., storage medium 311, 315) of server 102.

In one embedment, such a similarity analysis is performed by vectorizing the analyzed semantics of the received query as well as the analyzed semantics of the previously analyzed queries which are stored in the data structure discussed above. In one embodiment, analyzer 201 calculates the distance between such vector representations, such as by calculating the cosine similarity between such vector representations (e.g., between the vector representation of the analyzed semantics of the received query and the vector representation of the analyzed semantics of a prior analyzed query). Such a distance represents the degree of similarity between the analyzed semantics of the received query and the analyzed semantics of a prior query. In one embodiment, in connection with calculating the cosine similarity, the closer the value is to 1, the higher the semantic similarity.

In one embodiment, analyzer 201 determines if the analyzed semantics of the received query is within a threshold degree of similarity, which may be user-designated, to the analyzed semantics of a prior query based on determining if the calculated distance between the vector representations of such analyzed semantics exceeds a threshold value (e.g., 0.95), which may be user-designated.

If the analyzed semantics of the received query is within a threshold degree of similarity to the analyzed semantics of a prior query, then, in operation 404, interaction module 202 of server 102 obtains the answer to the prior query.

In operation 405, interaction module 202 of server 102 presents the obtained answer in the response to the received query. That is, interaction module 202 issues a response to the query requesting information, which includes the answer to the prior query with analyzed semantics that are within a threshold degree of similarity to the analyzed semantics of the received query.

As discussed above, in one embodiment, answers to queries are stored in a data structure (e.g., table). For example, answers to queries that are provided to users by interaction module 202 are stored in such a data structure. In one embodiment, such answers stored in the data structure are associated with the queries. As a result, upon interaction module 202 identifying the query in the data structure whose analyzed semantics are within a threshold degree of similarity to the analyzed semantics of the received query, interaction module 202 is able to identify the associated answer. Such an answer is then presented as the response to the received query.

Returning to operation 403, if, however, the analyzed semantics of the received query is not within a threshold degree of similarity to the analyzed semantics of a prior query, then, in operation 406, searching engine 203 of server 102 searches knowledge base 105 for the answer to the received query based on the analyzed semantics.

As stated above, a knowledge base, such as knowledge base 105, as used herein, refers to either centralized or one or more distributed repositories of information that store data and knowledge related to a specific topic, product, or service. For example, the user of computing device 101 may have provided the query of “What hobbies did John Doe have?” Based on analyzing the semantics of the query by analyzer 201, searching engine 203 searches knowledge base 105 for information pertaining to the hobbies of Country A Prime Minister John Doe.

In one embodiment, searching engine 203 compares the meaning of the semantic representations of the knowledge base entries with the semantic representation of the received query. For example, in one embodiment, the analyzed semantics of the received query may be represented as a vector as discussed above. Furthermore, in one embodiment, the knowledge base entries are represented as vectors. For example, in one embodiment, each piece of information in the knowledge base is converted into a vector representation, such as via the word embedding technique. As a result, a numerical comparison of semantic similarity may be performed between the query and the knowledge base entries.

In one embodiment, searching engine 203 performs such a numerical comparison by performing a vector similarity search, which compares the query vector to the vectors of each knowledge base entry to identify the most semantically similar ones. In one embodiment, such results may be ranked based on relevance, such as the distance between the vectors, the context of the knowledge base entry, and any additional semantic information to refine the ranking of potential answers.

In one embodiment, searching engine 203 identifies the knowledge base entry that best matches the semantic meaning of the query as corresponding to the answer to the query.

For example, the user of computing device 101 may have provided the query of “What hobbies did John Doe have?” Based on the analyzed semantics of the query, searching engine 203 searches knowledge base 105 for information pertaining to the hobbies of Country A Prime Minister John Doe. That is, based on the analyzed semantics of the query, searching engine 203 searches knowledge base 105 for an answer to the query. An example of an answer to such a query is provided below:
John Doe, the first Prime Minister of Country A, had several hobbies and interests outside of politics. Some of his known hobbies were:
1. Hiking—Ben-Gurion was an avid hiker and spent much of his free time exploring the desert and mountains of the region.
2. Reading—He was an avid reader and particularly enjoyed books on history and philosophy.
3. Writing—Ben-Gurion was a prolific writer and wrote many books and articles on politics and history.
4. Playing the violin—He was a skilled violin player and enjoyed playing classical music.
5. Gardening—Ben-Gurion had a love for gardening and enjoyed spending time tending to his plants and trees.
6. Studying languages—He had a passion for learning languages and was fluent in Hebrew, Yiddish, English, Russian, French, Spanish, and Turkish.
Overall, Ben-Gurion was a multifaceted person with a wide range of interests and hobbies.

In one embodiment, searching engine 203 searches knowledge base 105 for the answer to the query based on the analyzed semantics using various software tools, which can include, but are not limited to, IBM Watson® Discovery, Bloomfire®, etc.

In operation 407, validation module 204 of server 102 determines whether the answer provided by searching engine 203 includes a name associated with more than one individual, such as multiple well-known individuals.

For example, the answer could include a name, such as Michael Jackson, which could refer to multiple individuals, such as the singer Michael Jackson or the radio host Michael Jackson.

As discussed above, in one embodiment, validation module 204 determines whether the answer provided by searching engine 203 includes a name associated with more than one individual, such as multiple well-known individuals, by searching a data structure (e.g., table) containing a listing of celebrities, public figures, prominent persons, etc. who have the same name as other celebrities, public figures, prominent persons, etc. For example, in one embodiment, validation module 204 performs a search in such a data structure using the names included in the answer to determine if such a name also refers to another individual, including another well-known individual. Upon identifying a matching name in the data structure, validation module 204 may then conclude that such a name is associated with more than one individual. In one embodiment, such a data structure is populated by an expert. In one embodiment, such a data structure resides within the storage device (e.g., storage device 311, 315) of server 102.

If the answer provided by searching engine 203 includes a name associated with more than one individual, then, in operation 408, validation engine 204 generates a notification to the user, such as the user of computing device 101 that issued the query requesting information, requesting clarification as to which individual is discussed in the answer. In one embodiment, such a notification is sent to the user of computing device 101 that issued the query requesting information via an email message, a short message service (SMS) message, a mobile push notification (through an application), a web push notification (on a website), etc.

In one embodiment, upon receiving confirmation as to which individual is the correct individual that is named in the answer, validation engine 204 performs a subsequent image and/or video search from a predetermined list of resources involving that individual to determine the accuracy of the answer as discussed below.

Alternatively, in one embodiment, validation module 204 performs a subsequent image and/or video search for each individual (e.g., Michael Jackson the singer and Michael Jackson the radio host) to determine the accuracy of the answer as discussed below.

Alternatively, in one embodiment, validation engine 204 randomly selects one of the individuals (e.g., Michael Jackson the singer) as the individual that is allegedly named in the answer. Validation engine 204 then performs a subsequent image and/or video search from a predetermined list of resources involving that individual to determine the accuracy of the answer as discussed below. In such an embodiment, validation engine 204 provides an indication, such as to the user of computing device 101 that issued the query requesting information, regarding the existence of other individuals with the same name. In one embodiment, such a notification is sent to the user of computing device 101 that issued the query requesting information via an email message, a short message service (SMS) message, a mobile push notification (through an application), a web push notification (on a website), etc.

Returning to operation 407, if, however, validation module 204 determines that the answer provided by searching engine 203 does not include a name associated with more than one individual, then, in operation 409, validation module 204 proceeds with performing a subsequent image and/or video search from a predetermined list of resources, such as involving the individual mentioned in the answer, to determine the accuracy of the answer as discussed below.

As discussed above, in one embodiment, validation module 204 performs the subsequent image and/or video search from a predetermined list of resources to determine the level of accuracy of the answer (i.e., to validate the accuracy of the answer) by performing such a subsequent image and/or video search on online resources 106, which are provided from the predetermined list of resources. An online resource 106, as used herein, refers to any information, data, or tool that is accessible via a network, such as network 103, including images and videos, which can be accessed and used through a digital platform.

In one embodiment, validation module 204 performs the subsequent image and/or video search (including the subsequent image and/or video search performed in operations 408, 409) by looking for visual evidence of a specific activity mentioned in the answer. For example, referring to the example of an answer provided by searching engine 203 regarding John Doe, where the answer included the alleged fact that a hobby of John Doe was that he played the violin, specifically, that he was a skilled violin player and enjoyed playing classical music. As a result, in order to verify the accuracy of such a fact, validation module 204 performs a subsequent image and/or video search looking for visual evidence of John Doe playing the violin.

In one embodiment, validation engine 204 performs a keyword search in the answer provided by searching engine 203 for words directed to an activity, such as playing the violin. In one embodiment, validation engine 204 performs such a keyword search based on a data structure (e.g., table) that includes a listing of terms associated with activities. In one embodiment, validation engine 204 performs a lookup in such a data structure to identify any terms associated with activities that are listed in the answer provided by searching engine 203. Upon identifying such a matching term, validation engine 204 then performs the subsequent image and/or video search by looking for visual evidence of such a specific activity mentioned in the answer. In one embodiment, such a data structure is populated by an expert. In one embodiment, such a data structure is stored in the storage device (e.g., storage device 311, 315) of server 102.

In one embodiment, validation engine 204 performs a subsequent image and/or video search by looking for visual evidence of a specific activity by utilizing a search engine (e.g., Google®, Bing®, etc.). For example, a descriptive phrase (e.g., “John Doe playing violin”) is inputted into the search bar of the search engine. In one embodiment, validation engine 204 may indicate that such a search is a search for an image and/or video.

In one embodiment, validation module 204 analyzes the results of the image and/or video search performed by the search engine for visual evidence of a specific activity. For example, referring to the example above pertaining to the answer indicating that John Doe plays the violin, the search engine may indicate that there are no publicly available images with John Doe playing the violin. There are, however, publicly available images with John Doe writing as a hobby.

In one embodiment, validation module 204 analyzes the images and/or videos identified by the search engine to confirm that such images and/or videos provide visual evidence of a specific activity. In one embodiment, validation module 204 uses computer vision techniques, such as via machine learning models, to detect and track a person (e.g., John Doe) in the image and/or video. Such actions in the image and/or video may then be classified, such as based on body posture, movement patterns, and surrounding context. In one embodiment, such a classification is performed using object detection, pose estimation, and activity recognition. In one embodiment, validation module 204 utilizes various software tools for performing such an analysis of the images and/or videos, which can include, but are not limited to, Amazon Rekognition®, Microsoft® Azure® Cognitive Services, TensorFlow®, etc.

In one embodiment, validation module 204 analyzes the images and/or videos identified by the search engine to confirm that such images and/or videos provide visual evidence of a specific activity by first performing image/video preprocessing followed by feature extraction followed by activity classification.

In one embodiment, such image/video preprocessing involves object detection, which identifies the designated individual in each frame using object detection algorithms (e.g., Faster Region-Convolutional Neural Network, small data-driven) to isolate their body from the background. Furthermore, in one embodiment, such image/video preprocessing involves pose estimation, which utilizes pose estimation techniques (e.g., OpenPose) to extract key points on the person's body (e.g., joints) to analyze their posture and movement.

In one embodiment, feature extraction involves motion analysis, which analyzes the movement of the detected keypoints over time to identify patterns associated with specific activities. Furthermore, feature extraction involves contextual features, such as location, surrounding objects, or the scene, to improve activity recognition accuracy. In one embodiment, validation module 204 performs feature extraction using various software tools, which can include, but are not limited to, VisionTool, Matlab®, OpenCV®, etc.

In one embodiment, activity classification involves training a machine learning model (e.g., convolutional neural network) on labeled data of various activities to classify the detected actions in each frame. In one embodiment, activity classification involves using recurrent neural networks that are trained, such as via backpropagation through time, to identify activities based on the temporal relationships between video frames. As a result, such a trained recurrent neural network is able to classify actions, such as actions being performed between video frames.

In one embodiment, validation module 204 performs the subsequent image and/or video search (including the subsequent image and/or video search performed in operations 408, 409) by employing face recognition techniques to identify all individuals associated with the answer.

For example, if the answer mentions an individual, such as John Doe, then validation module 204 may employ a face recognition technique to identify John Doe in the images and/or videos that were searched by validation module 204, such as the images and/or videos that were searched in online resources 106. In one embodiment, validation module 204 performs face recognition to identify a particular individual in an image and/or video by first detecting a face within the image and/or video and analyzing its key facial features, such as the distance between the eyes, shape of the nose, jawline, etc., so as to create a unique “faceprint” which is compared to a known image of the person (e.g., John Doe) in question. In one embodiment, knowledge base 105 may be populated with images of individuals that are known to be correct. As a result, validation module 204 may be configured to search knowledge base 105 for an image of an individual mentioned in the answer and use such an image when it performs face recognition in connection with the images and/or videos that were searched by validation module 204. In one embodiment, such images of individuals that are known to be correct are populated in knowledge base 105 by an expert. In one embodiment, images of individuals that are known to be correct are populated in a storage device (e.g., storage device 311, 315) of server 102.

In one embodiment, validation module 204 utilizes various software tools for employing a face recognition technique as discussed above to identify an image of an individual mentioned in the answer in the images and/or videos that were searched by validation module 204, such as the images and/or videos that were searched in online resources 106, which can include, but are not limited to, FaceFirst®, Amazon Rekognition®, DeepFace, etc.

In one embodiment, validation module 204 analyzes the results of the image and/or video searched for visual evidence of a specific activity being performed by a specific individual mentioned in the answer to determine a level of accuracy of the answer by determining how well the visual evidence in the searched image and/or video aligns with the activity and/or individual mentioned in the query.

For example, in one embodiment, validation module 204 trains a machine learning model to determine how well the visual evidence in the searched image and/or video aligns with the activity and/or individual mentioned in the query. In one embodiment, such a determination is provided as a value, such as a number between 0 and 1, where the value of 1 corresponds to a perfect alignment between the visual evidence in the searched image and/or video and the activity and/or individual mentioned in the query and where the value of 0 corresponds to the opposite case, in which there is no alignment between the visual evidence in the searched image and/or video and the activity and/or individual mentioned in the query.

In one embodiment, validation module 204 trains the machine learning model to determine how well the visual evidence in the searched image and/or video aligns with the activity and/or individual mentioned in the query based on a sample data set, which may include images and/or videos of various activities as well as a value associated with each image or video which indicates how closely aligned such an image or video is to a particular activity (e.g., reading a book, playing the violin) and/or individual (e.g., famous people, public figures). In one embodiment, such a sample data set is populated by an expert. In one embodiment, such a sample data set is stored in knowledge base 105. In one embodiment, such a sample data set is stored in a storage device (e.g., storage device 311, 315) of server 102.

Furthermore, in one embodiment, the sample data set discussed above is referred to herein as the “training data,” which is used by a machine learning algorithm to make predictions or decisions, such as how well the visual evidence in the searched image and/or video aligns with the activity and/or individual mentioned in the query. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

Referring to FIG. 4B, in conjunction with FIGS. 1-3, in operation 410, validation module 204 determines whether the accuracy of the answer is below a threshold level, which may be user-designated.

As stated above, upon training the machine learning model to determine how well the visual evidence in the searched image and/or video aligns with the activity and/or individual mentioned in the query, validation module 204 determines the accuracy of the answer based on inputting the search results (results of the subsequent image and/or video search, including the results of the subsequent image and/or video search for each of the individuals when there is more than one individual mentioned in the answer) into the trained machine learning model. In one embodiment, the trained machine learning model outputs a value, such a value between 0 and 1, which indicates the level of accuracy of the answer.

In one embodiment, interaction module 202 compares such a value to a threshold value, which may be user-designated, to determine if the accuracy of the answer is below a threshold level.

If the accuracy of the answer is not below the threshold level, then, in operation 411, interaction module 202 presents the answer in the response to the received query.

If, however, the accuracy of the answer is below the threshold level, then, in operation 412, interaction module 202 of server 102 excludes the answer from being provided in the reply to the answer. In this manner, the risk of presenting incorrect information is mitigated thereby improving the reliability and accuracy of responses generated by AI chatbots.

Furthermore, the principles of the present disclosure improve the technology or technical field involving artificial intelligence chatbots.

As discussed above, AI chatbots are designed to understand a user's needs, preferences, and intent without the need for a human operator. For example, AI chatbots use natural language processing (NLP) and machine learning (ML) to understand and respond to user queries. They can adapt to user inputs over time and handle a wider range of issues more accurately and efficiently than traditional chatbots. AI chatbots are used in a variety of applications, including customer service. For example, AI chatbots are used for answering frequently asked questions, providing product recommendations, and facilitating transactions. AI chatbots are also used in e-commerce (e.g., providing personalized recommendations), healthcare (e.g., performing patient intake and appointment scheduling), market research (e.g., collecting survey responses), education (e.g., helping students with their homework), etc. Unfortunately, such AI chatbots, such as OpenAI's ChatGPT®, may sometimes provide incorrect information with confidence, a phenomenon known as “information hallucination.” Information hallucination refers to when an artificial intelligence model, such as an AI chatbot, generates seemingly plausible but factually incorrect information, presenting it as if it were true, essentially “hallucinating” details that are not based on true facts. As a result, information hallucination can lead to misleading or harmful information being disseminated. Currently, attempts have been made to improve the accuracy of the information provided by AI chatbots, such as by implementing fact-checking mechanisms. Unfortunately, such attempts were found as not sufficiently effective to enhance the accuracy of the information provided by AI chatbots.

Embodiments of the present disclosure improve such technology by receiving a query requesting information (e.g., query requesting the summarization of the key points of the article entitled “The Impact of AI on the Workplace”). The semantics of the received query is then analyzed. Analyzing the semantics of a query, as used herein, refers to examining the underlying meaning and context of a question, search phrase, or task request, to understand the user's intent and the relationships between the concepts mentioned in the query. The knowledge base may then be searched for the answer to the received query based on the analyzed semantics. A knowledge base, as used herein, refers to either centralized or one or more distributed repositories of information that store data and knowledge related to a specific topic, product, or service. For example, based on analyzing the semantics of the query of “What hobbies did John Doe have?”, the knowledge base is searched for information pertaining to the hobbies of Country A's first prime minister, John Doe, thereby forming an answer to the query. For example, the answer to the query may be that John Doe, the first prime minister of Country A, had several hobbies and interests outside of politics, including playing the violin. A subsequent image and/or video search from a predetermined list of resources may then be performed to determine the level of accuracy of the answer (i.e., to validate the accuracy of the answer). For example, a subsequent image and/or video search may then be performed to validate the accuracy of the answer, such as John Doe playing the violin. In one embodiment, a machine learning model is trained to determine how well the visual evidence in the searched image and/or video aligns with the activity and/or individual mentioned in the query thereby determining the accuracy of the answer to the received query. After training the machine learning model to determine how well the visual evidence in the searched image and/or video aligns with the activity and/or individual mentioned in the query, the search results (results of the subsequent image and/or video search) are inputted into the trained machine learning model, which outputs a value, such a value between 0 and 1, which indicates the level of accuracy of the answer. The answer may then be presented in the response to the query if the accuracy of the answer is not below a threshold level, which may be user-designated. Alternatively, the answer may be excluded from being provided in the response to the query if the accuracy of the answer is below the threshold level. In this manner, the risk of presenting incorrect information is mitigated thereby improving the reliability and accuracy of responses generated by AI chatbots. Furthermore, in this manner, there is an improvement in the technical field involving artificial intelligence chatbots.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for enhancing accuracy of information provided by artificial intelligence chatbots, the method comprising:
receiving a query requesting information;
analyzing semantics of the query;
searching a knowledge base for an answer to the query based on the analyzed semantics of the query;
performing one or more of a subsequent image search and a subsequent video search from a predetermined list of resources to determine an accuracy of the answer forming search results;
training a machine learning model to determine how well visual evidence in the subsequent searched image and/or video aligns with an activity and/or an individual mentioned in the query;
inputting the search results into the trained machine learning model, wherein the machine learning model outputs a value which indicates a level of accuracy of the answer; and
excluding the answer from being provided in a reply to the query in response to the accuracy of the answer being below a threshold level.

2. The computer-implemented method as recited in claim 1 further comprising:
determining if the analyzed semantics of the query is within a threshold degree of similarity to analyzed semantics of a prior query requesting information; and
performing the subsequent image and/or video search from the predetermined list of resources to determine the accuracy of the answer in response to the analyzed semantics of the query not being within the threshold degree of similarity to the analyzed semantics of the prior query requesting information.

3. The computer-implemented method as recited in claim 1 further comprising:
determining if the answer includes a name associated with more than one individual.

4. The computer-implemented method as recited in claim 3 further comprising:
generating a notification to a user requesting clarification as to which individual is discussed in the answer in response to determining that the answer includes a name associated with more than one individual.

5. The computer-implemented method as recited in claim 3 further comprising:
performing the subsequent image and/or video search from the predetermined list of resources for each of a plurality of individuals to determine the accuracy of the answer in response to determining that the answer includes a name associated with more than one individual.

6. The computer-implemented method as recited in claim 1 further comprising:
presenting the answer in the reply to the query in response to the accuracy of the answer not being below the threshold level.

7. The computer-implemented method as recited in claim 1, wherein the subsequent image and/or video search comprises looking for the visual evidence of a specific activity mentioned in the answer.

8. The computer-implemented method as recited in claim 1, wherein the subsequent image and/or video search comprises employing a face recognition technique to identify all individuals associated with the answer.

9. A computer program product for enhancing accuracy of information provided by artificial intelligence chatbots, the computer program product comprising:
a set of one or more computer-readable storage media; and
program instructions, collectively stored in the set of one or more computer-readable storage media, for causing a processor set to perform the following computer operations:
receiving a query requesting information;
analyzing semantics of the query;
searching a knowledge base for an answer to the query based on the analyzed semantics of the query;
performing one or more of a subsequent image search and a subsequent video search from a predetermined list of resources to determine an accuracy of the answer forming search results;
training a machine learning model to determine how well visual evidence in the subsequent searched image and/or video aligns with an activity and/or an individual mentioned in the query;
inputting the search results into the trained machine learning model, wherein the machine learning model outputs a value which indicates a level of accuracy of the answer; and
excluding the answer from being provided in a reply to the query in response to the accuracy of the answer being below a threshold level.

10. The computer program product as recited in claim 9, wherein the program instructions cause the processer set to perform the following computer operation:
determining if the analyzed semantics of the query is within a threshold degree of similarity to analyzed semantics of a prior query requesting information; and
performing the subsequent image and/or video search from the predetermined list of resources to determine the accuracy of the answer in response to the analyzed semantics of the query not being within the threshold degree of similarity to the analyzed semantics of the prior query requesting information.

11. The computer program product as recited in claim 9, wherein the program instructions cause the processer set to perform the following computer operation:
determining if the answer includes a name associated with more than one individual.

12. The computer program product as recited in claim 11, wherein the program instructions cause the processer set to perform the following computer operation:
generating a notification to a user requesting clarification as to which individual is discussed in the answer in response to determining that the answer includes a name associated with more than one individual.

13. The computer program product as recited in claim 11, wherein the program instructions cause the processer set to perform the following computer operation:
performing the subsequent image and/or video search from the predetermined list of resources for each of a plurality of individuals to determine the accuracy of the answer in response to determining that the answer includes a name associated with more than one individual.

14. The computer program product as recited in claim 9, wherein the program instructions cause the processer set to perform the following computer operation:
presenting the answer in the reply to the query in response to the accuracy of the answer not being below the threshold level.

15. The computer program product as recited in claim 9, wherein the subsequent image and/or video search comprises looking for the visual evidence of a specific activity mentioned in the answer.

16. The computer program product as recited in claim 9, wherein the subsequent image and/or video search comprises employing a face recognition technique to identify all individuals associated with the answer.

17. A system, comprising:
a memory for storing a computer program for enhancing accuracy of information provided by artificial intelligence chatbots; and
a processor connected to the memory, wherein the processor is configured to execute program instructions of the computer program comprising:
receiving a query requesting information;
analyzing semantics of the query;
searching a knowledge base for an answer to the query based on the analyzed semantics of the query;
performing one or more of a subsequent image search and a subsequent video search from a predetermined list of resources to determine an accuracy of the answer forming search results;
training a machine learning model to determine how well visual evidence in the subsequent searched image and/or video aligns with an activity and/or an individual mentioned in the query;
inputting the search results into the trained machine learning model, wherein the machine learning model outputs a value which indicates a level of accuracy of the answer; and
excluding the answer from being provided in a reply to the query in response to the accuracy of the answer being below a threshold level.

18. The system as recited in claim 17, wherein the program instructions of the computer program further comprise:
determining if the analyzed semantics of the query is within a threshold degree of similarity to analyzed semantics of a prior query requesting information; and
performing the subsequent image and/or video search from the predetermined list of resources to determine the accuracy of the answer in response to the analyzed semantics of the query not being within the threshold degree of similarity to the analyzed semantics of the prior query requesting information.

19. The system as recited in claim 17, wherein the program instructions of the computer program further comprise:
determining if the answer includes a name associated with more than one individual.

20. The system as recited in claim 19, wherein the program instructions of the computer program further comprise:
generating a notification to a user requesting clarification as to which individual is discussed in the answer in response to determining that the answer includes a name associated with more than one individual.
